(19) United States
(12) Patent Application Publication
(10) Pub. No.: US 2009/0081116 A1
(43) Pub. Date: Mar. 26, 2009

(54) Rare vanadium derivative

(76) Inventor: Abdoulaye Dieng, Parlin, NJ (US)

Correspondence Address: ABDOULAYE DIENG, 4507 WELLS DR., PARLIN, NJ, 08859, US

(21) Appl. No.: 11/796,157

(22) Filed: Sep. 21, 2007

(51) Int. Cl. C01G 37/00

(52) U.S. Cl. 423/595

(57) ABSTRACT

The unique method of synthesis of chromium vanadate is performed using chromium chloride and sodium metavanadate. Methanol is used as a solvent. Zinc and/or palladium can be used as a catalyst. After reacting, the filtrate will be evaporated and the obtained substance is Chromium vanadate. The precipitate is sodium chloride.

This substitute contains no new matter.

### VANADIUM DERIVATIVE SYNTHESIS

This substitute contains no new matter.

1. A synthesis of Chromium vanadate is being performed for the first time under the specific chemical conditions as shown below.
3NaVO3+CrC13→Cr2V4O13V2O5 or [Cr(VO3)3]+3 NaCl
Sodium Metavanadate (or Ammonium Metavanadate) +chromium chloride (or Nitrate) →CHROMIUM VANADATE and Sodium Chloride (or Nitrate)

2. The chemical reaction can be conducted under the following conditions
pH: 5-7 and Zinc as a catalyst or palladium
The reaction will be carried in Methanol as a solvent and cooled for precipitation of the Sodium chloride (white) separated from the Vanadium derivative (Brown).
The other option would be to conduct heating and cooling operations under Specified conditions to eliminate the nitrates and get the same Vanadium Derivative without using the solvent stated above.

3. The obtained Vanadium derivative (also called Chrovasat) will be useful as catalyst in other chemical reactions to recreate difficult synthesis of Cr and/or Vanadium. With the very low toxicity of this component, it could be used wherever a Vanadium/chromium is deemed useful.
